(19) United States
(12) Patent Application Publication
(10) Pub. No.: US 2005/0049964 A1
(43) Pub. Date: Mar. 3, 2005

(54) Financial transaction card with automatic payment feature

(76) Inventors: Mary Jo Winterer, Norwalk, CT (US); Peter S. Weinberger, New Fairfield, CT (US)

Correspondence Address: BAKER & BOTTS, 30 ROCKEFELLER PLAZA, NEW YORK, NY, 10112, US

(21) Appl. No.: 10/757,317

(22) Filed: Jan. 14, 2004

Related U.S. Application Data
(60) Provisional application No. 60/439,899, filed on Jan. 14, 2003.

(51) Int. Cl. G06F 17/60

(52) U.S. Cl. 705/39

(57) ABSTRACT

A financial transaction payment system is provided which includes a consumer depository account maintained by a first financial institution holding funds on behalf of a consumer, and a payment card for conducting one or more transactions and incurring charges associated with each such transaction. The card is issued to the consumer by a second financial institution and is linked to the depository account maintained at said first institution for covering the charges incurred on the card.

### PRIORITY APPLICATION

This application is based on U.S. provisional application No. 60/439,899 filed on Jan. 14, 2003, entitled “Financial Transaction Card With Automatic Payment Feature” which is hereby incorporated by reference.

### BACKGROUND OF THE INVENTION

This invention relates to a method and system for conducting financial transactions using payment cards and, more particularly, to a method and system for offering a charge or credit card to consumers that would be linked to a consumer's depository account, which depository account does not have to be maintained at the card-issuing financial institution.

In today's marketplace, payment cards—such as credit, debit, and prepaid cards—are ubiquitous methods of payment. These payment cards may be issued by individual card companies or by financial institutions that are members of a payment association (such as MasterCard (R) International Incorporated). As used in this application, the term “payment card” includes not only physical payment cards, but also virtual payment cards in which the payment account information is stored in digital or electronic form, such as in a digital wallet.

### SUMMARY OF THE INVENTION

The financial transaction card of the present invention offers a new way for the financial institutions to offer a charge card to consumers. This card would be linked to a consumer's depository account, which does not have to be maintained at the card-issuing financial institution. The charges that are compiled on this financial transaction card by the consumer would be automatically deducted from the consumer's depository account using the Automated Clearing House (ACH) network. ACH deductions would be made from the consumer's depository account on a periodic basis (for example, on a weekly basis) as agreed upon by the cardholder and issuing financial institution at the time of acquisition. The spending limit offered to the cardholder would be refreshed at the designated time period, to reflect the original line of credit. In return for using this card, cardholders may receive loyalty points redeemable for rewards.

### BRIEF DESCRIPTION OF THE DRAWINGS

Exemplary embodiments of the present invention will now be described in detail with reference to the accompanying drawings in which:

FIG. 1 is a flow diagram illustrating setting up an account with a financial transaction card according to a preferred embodiment of the present invention;

FIG. 2 is a flow diagram illustrating the use of a financial transaction card according to a preferred embodiment of the present invention;

FIG. 3 is a flow diagram illustrating the settling of an account with a financial transaction card according to a preferred embodiment of the present invention; and

FIG. 4 is a flow diagram illustrating the format of a billing statement according to a preferred embodiment of the present invention.

### DETAILED DESCRIPTION OF THE INVENTION

The present invention relates to a financial transaction payment method and system utilizing financial transaction cards that offers a unique way for the financial institutions to offer credit cards to consumers that are linked to the consumers' depository accounts that are not maintained by the card issuing financial institution. Below is the detailed description of:
a) the card and its differentiating features and functionality;
b) the process of how this account would be set up;
c) how the transaction would be processed if a cardholder uses this card;
d) how the account would be settled by the issuing bank and the financial institution holding the cardholder's deposit account; and
e) a preferred embodiment of what a billing statement would look like.
The card and its differentiating features and functionality

This proposed financial transaction card offers a new way for the financial institutions to offer a credit card to consumers that is linked to the consumers' depository account that is not maintained by the card issuing financial institution. The charges that are compiled on this financial transaction card by the consumers would be automatically deducted using the Automated Clearing House (ACH) network from the consumers' depository account on a periodic basis (for example, on a weekly basis) as agreed upon by cardholders and the card-issuing financial institutions. The spending limit offered to the consumers would be refreshed to reflect the original line of credit after every periodic deduction from the consumer's depository account has taken place to cover the previous charges incurred on the credit cards. In return for using this card, cardholders may receive redeemable loyalty points.

The transaction cards of the present invention provide banks a vehicle to issue a card that is funded or paid by a deposit account housed at another bank. Thus, a bank could go outside its branch markets and thereby expand its portfolio and/or its brand awareness. Additionally, the transaction cards of the present invention can be used within the small business sector, where small businesses may prefer the convenience of automatic payment of their credit cards on a predetermined basis, without having to move their checking accounts to different banks to take advantage of the benefits offered by the credit cards of certain banks. From a cardholder perspective, the transaction card of the present invention provides the cardholder with the ability to get a debit-like product with the benefits of a credit card offering (for example, a listing of all purchases separately) and a card offering from an institution other than the cardholder's deposit account institution.
The process of setting up the account

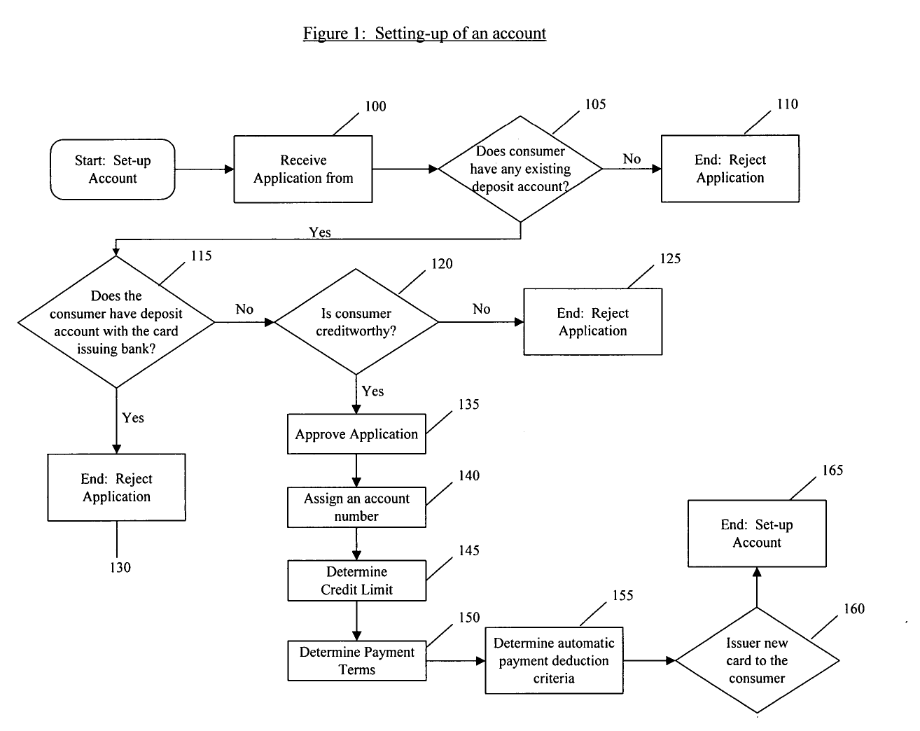

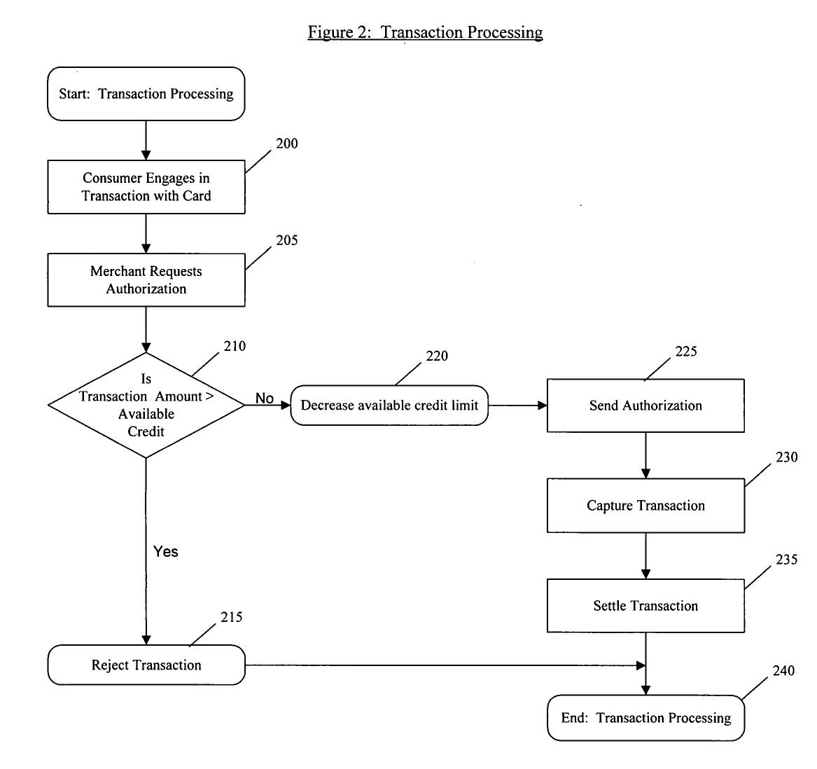

With regards to the flow chart of FIG. 1, to start the process and solicit new accounts, the issuing bank offers an application 100 to obtain this proposed financial transaction card to new consumers. The process begins with the card-issuing bank reviews the application 105, 115, 120 and selects the cardholders based on the following criteria:
The applicant has to have a deposit account with a financial institution 105.
If the applicant has a deposit account but it is with the same institution that is offering the new financial transaction card, the application is rejected 110.
If the applicant holds a deposit account with any institution other than the card-issuing bank 115, the application moves to the next step where the consumer's creditworthiness is determined 120. If the applicant is not deemed to be creditworthy, the application is rejected 125. Otherwise, the application is approved 135.
Upon approval, the card-issuing bank assigns an account number to the application 140, determines the credit limit 145 that would be offered to this applicant, and determines the payment terms 150 (described in greater detail later in this section).
Finally, the bank issues its approved customers a new card 160 to be used by them wherever such cards are accepted.
How the transaction would be processed when a cardholder uses the card

FIG. 2 provides a flow chart illustrating the transaction proceeding. When a cardholder uses the card 200, the transaction would be processed in a normal manner, starting with the merchant making a request with the issuing bank for authorization to complete the transaction 205. If the transaction amount is less than the available credit limit 210, the transaction is approved. Otherwise, it is rejected 215. With the approval of the transaction, the credit line is reduced by the amount the transaction is approved for 220 and authorization sent 225. The captured transaction 230 is then sent to the issuing bank via acquirer and settled 235 at the end of the day for the merchant, thus concluding the transaction 240.
How the account would be by the issuing bank and the financial institution holding the cardholders' deposit account

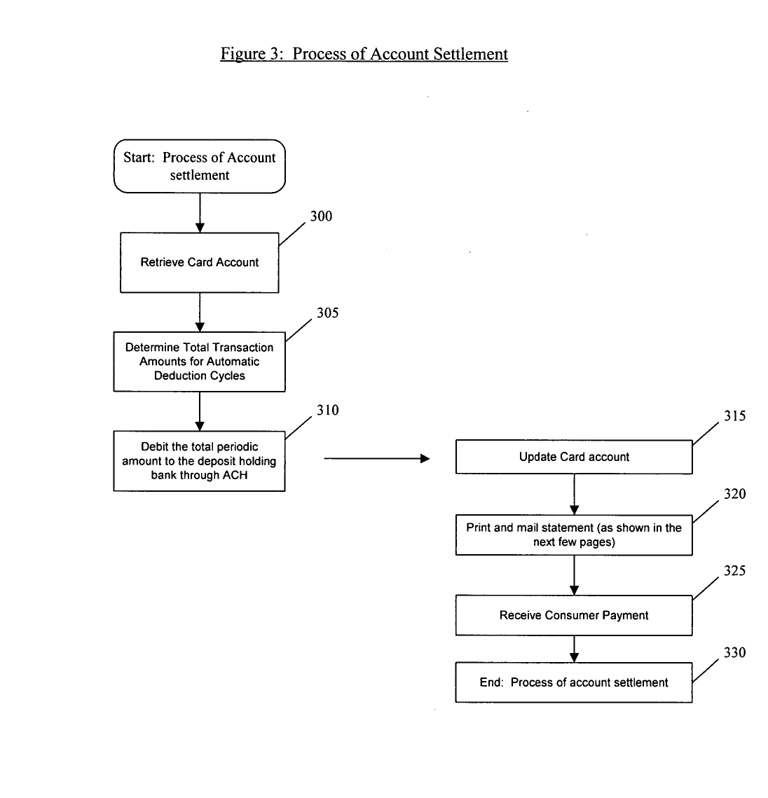

FIG. 3 provides a flow diagram illustrating the process of account settlement (between the consumer and the card-issuing bank). After retrieving the card account 300, the card-issuing bank would add and determine the total amount that has been charged to the card for the Automatic Deduction cycles 305. The deduction cycles are predetermined by the issuing bank in conjunction with the cardholder and can be, for example, on a weekly basis or on a monthly basis. The total amount charged to the card for a cycle is totalled and sent as a direct debit to the cardholder's deposit account via the Automated Clearing House (ACH) 310. The receiving depository bank would debit the cardholder's deposit account and credit the issuing bank with that amount, updating the account information 315 in the process. This process would take place for each deduction cycle. In this manner, the card-issuing bank would have the outstanding balances paid off in regular periods and the customer would have the full credit line open to them for purchases. The card-issuing bank would record all the transactions, which include all the charges made on the card and the credit received from the cardholders' deposit account on a periodic basis, and have a printout mailed to cardholders in the form of a statement 320 on a regular basis. The cardholder would receive the statements and verify that everything is billed properly and continue to use the card and receive rewards.
What a billing statement would look like

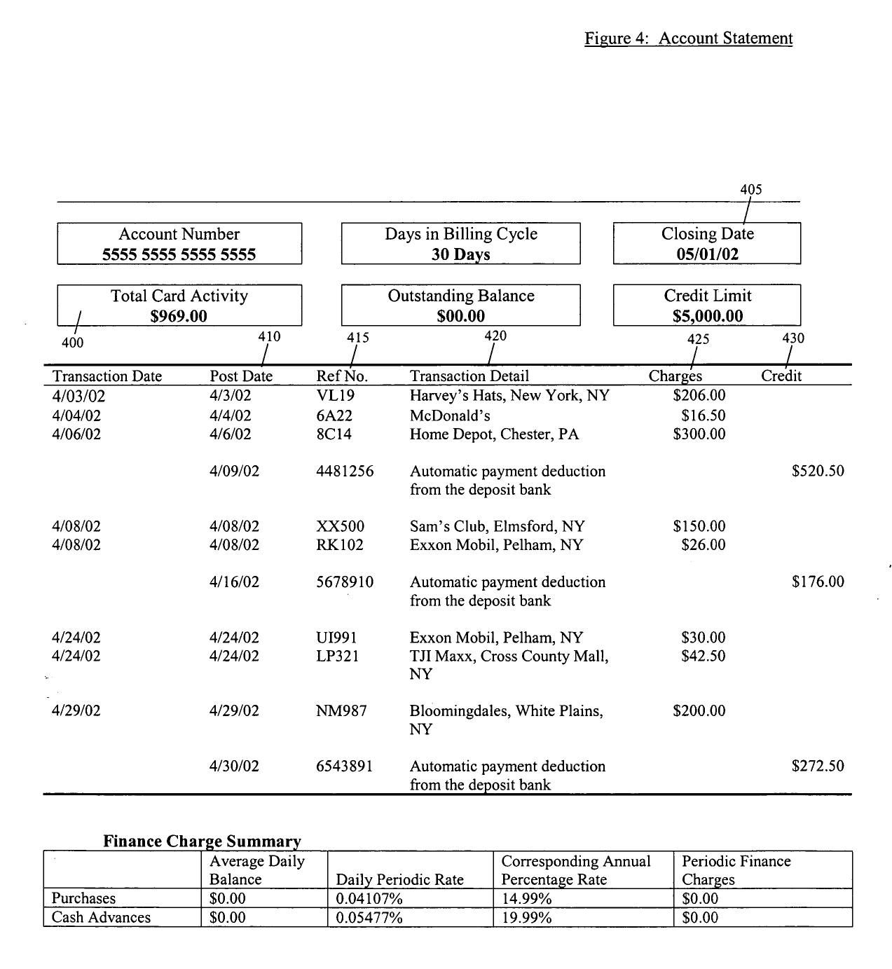

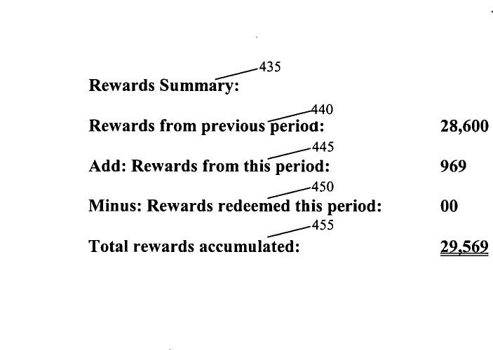

FIG. 4 illustrates what an account or billing statement might look like. The statements could be mailed to the cardholders or presented on-line (as agreed upon by the card-issuing bank and the cardholder) and would include all the charges as well as the credits posted to the account (total card activity 400) on a periodic basis to cover those charges. For both types of transactions, the following information would be provided:
the date of the transaction 405;
the post date 410 (date when the transaction was posted to the cardholder's account);
the reference number 415 (a unique number assigned to each transaction for the purpose of identification for issues such as dispute resolution);
transaction detail 420 indicating the merchant or the purpose of the transaction for ease of reconciliation;
the amount charged 425 for each transaction; and
the credit 430 that would be posted on a periodic basis.

Additionally, the statement would also provide, in a separate section details about the rewards that the cardholder has accumulated through transactions made using the card in a reward summary 435. Specifically, the statement would provide the following information:
total rewards 440 from prior purchases net of any reward points redeemed;
additional rewards 445 accumulated in the current billing period;
minus any reward points redeemed 450 in the current billing period; and
net total rewards 455 at the end of the current billing period.

Although the present invention has been described with reference to certain preferred embodiments, various modifications, alterations, and substitutions will be known or obvious to those skilled in the art without departing from the spirit and scope of the invention.

1. A financial transaction payment system, comprising: a consumer depository account maintained by a first financial institution holding funds on behalf of said consumer; and
a payment card for conducting one or more transactions and incurring charges associated with each such transaction, said card being issued to said consumer by a second financial institution, said card further being linked to said depository account maintained at said first institution for covering said charges.

2. The financial transaction payment system of claim 1, further comprising:
deducting means for automatically deducting from said depository account on a periodic basis an amount to pay a portion or all of said charges.

3. The financial transaction payment system of claim 2, wherein a credit limit is associated with said card, which limit is reduced based on said charges, and refreshed automatically as a function of said deducting means.

4. The financial transaction payment system of claim 3, further comprising:
billing means operated by said second financial institution for periodically informing said consumer of said charges made on the card and of the amount received from said consumer depository account to cover said charges.

5. A method for conducting financial transactions comprising:
establishing a consumer depository account maintained by a first financial institution holding funds on behalf of said consumer; and
issuing a payment card for conducting one or more transactions and incurring charges associated with each said transaction, said card being issued to said consumer by a second financial institution, said card further being linked to said depository account maintained at said first institution for covering said charges.

6. The method of claim 5, further comprising:
automatically deducting from said depository account on a periodic basis an amount to pay a portion or all of said charges.

7. The method of claim 6, wherein a credit limit is associated with said card, which limit is reduced based on said charges, and refreshed automatically as a function of said automatically deducting step.

8. The method of claim 7, further comprising:
periodically informing said consumer by said second financial institution of said charges made on the card and of the amount received from said consumer depository account to cover said charges.
